(19) United States
(12) Patent Application Publication
(10) Pub. No.: US 2026/0105860 A1
(43) Pub. Date: Apr. 16, 2026

(54) AI4Echolalia - An AI Educational Speech Companion for Parents

(71) Applicant: Tarun Kumar Chawdhury, Elk Grove, CA (US)

(72) Inventor: Tarun Kumar Chawdhury, Elk Grove, CA (US)

(73) Assignee: DLYog Lab Research Services LLC, Elk Grove, CA (US)

(21) Appl. No.: 18/916,728

(22) Filed: Oct. 16, 2024

(51) Int. Cl. G09B 19/04; G10L 15/26

(52) U.S. Cl. CPC G09B 19/04; G10L 15/26

(57) ABSTRACT

The present invention, AI4Echolalia™, is an AI-driven educational tool to assist parents in the speech development of children with echolalia. The system utilizes Generative AI technologies, including speech-to-text, text-to-speech, and large language models (LLMs), to detect and differentiate between immediate and delayed echolalia. The app provides personalized prompts and real-time feedback, helping to reduce repetitive speech patterns and encourage spontaneous communication. A unique dataset of prompts, child responses, and follow-up prompts, based on the inventor's experience, improves the app's personalized feedback. The system includes hands-free mode, session logs, and text-based chat for review and ongoing adaptation to each child's progress. The invention integrates ethical AI considerations for privacy and is scalable using cloud technologies to support a broad user base.

### CROSS-REFERENCE TO RELATED APPLICATIONS

This application claims no cross-reference to any related patent applications. No prior applications have been filed related to the technology, methods, or processes described in this application.

### BACKGROUND OF THE INVENTION

The present invention relates to a novel approach in assisting parents of children with special needs, specifically those facing speech delays and challenges related to echolalia. Current solutions in the market, such as professional speech therapy, are limited in both availability and accessibility. Parents often face months-long wait times before securing appointments with speech therapists. Once treatment begins, therapy sessions are typically brief (around 30 minutes per week) and insufficient to address the ongoing speech development needs of children, especially those with conditions like echolalia. As a parent of a child with special needs, the inventor has first-hand experience of the challenges families face in accessing adequate speech therapy resources. After enduring a six-month wait for speech therapy appointments and experiencing the constraints of receiving therapy only once every few months, the need for a complementary educational tool became clear. This personal experience, combined with the limitations of existing resources, inspired the development of the present invention. The invention aims to provide parents with a real-time, AI-driven educational tool that complements professional speech therapy, filling in the gaps in access and availability. The app uses AI technologies, including speech-to-text, large language models (LLMs), and text-to-speech, to support parents in observing, guiding, and improving their child's speech development between professional sessions. By allowing parents to record and analyze conversations, receive real-time feedback, and track progress over time, the invention serves as a vital complementary tool for addressing immediate and delayed echolalia. This approach is unique, leveraging cutting-edge AI and cloud technologies to empower parents as active participants in their child's speech development, making it a solution born out of personal necessity and a desire to help other families facing similar challenges.

### SUMMARY OF THE INVENTION

The present invention, AI4Echolalia™, is an AI-powered educational tool designed to assist parents of children with special needs, particularly those experiencing speech challenges related to immediate and delayed echolalia. The app leverages Generative AI and various AI-based speech-to-text and text-to-speech technologies to provide real-time detection and support for parents. The app allows parents to automatically detect whether their child is exhibiting immediate or delayed echolalia during real-time conversations, utilizing advanced AI algorithms to analyze and classify speech patterns. Through real-time feedback, parents are guided on how to respond effectively to their child's speech, improving the child's ability to develop independent communication skills. In addition to real-time echolalia detection, AI4Echolalia™ provides ongoing progress tracking, baseline assessments, and tailored prompts, allowing parents to participate more actively in their child's speech development journey. The app serves as a complementary tool to professional speech therapy, bridging the gap between limited therapy sessions and the continuous support that parents can offer at home. By incorporating cutting-edge AI technologies and a user-friendly interface, AI4Echolalia™ empowers parents with personalized support, making speech development education more accessible and scalable for families of children with special needs.

### BRIEF DESCRIPTION OF DRAWINGS

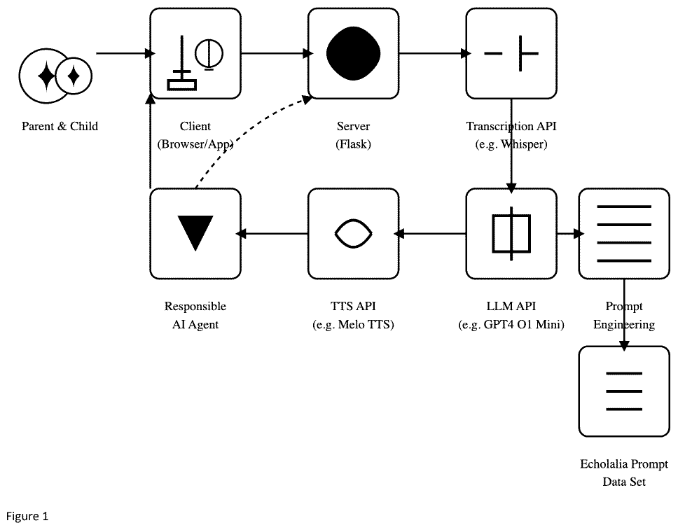

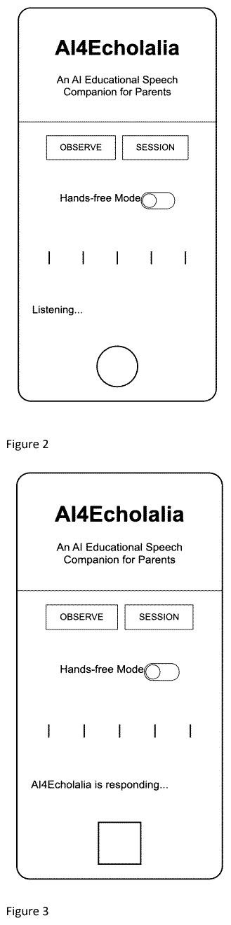

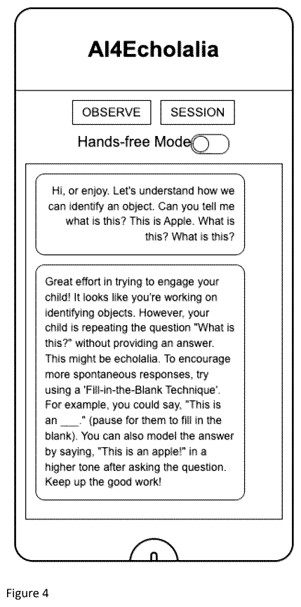

The accompanying drawing (FIG. 1) illustrates the workflow of the AI4Echolalia™ system, showing how real-time interactions between the parent and child are processed through the client-side application (browser or app) and communicated with a server using Flask. The speech from these interactions is transcribed into text using a Transcription API (e.g., Whisper), which is then processed by a Language Learning Model (LLM) API (e.g., GPT4 O1 Mini) to detect whether the child's speech is immediate or delayed echolalia. Based on this analysis, appropriate prompts are generated using Prompt Engineering, and stored in the Echolalia Prompt Dataset for future refinement. The system then utilizes a Text-to-Speech (TTS) API (e.g., Melo TTS) to convert the feedback into spoken guidance for the parent. The workflow is managed by a Responsible AI Agent to ensure ethical standards and privacy considerations are maintained throughout the process. FIG. 2 illustrates the main user interface of the AI4Echolalia™ app, showcasing options for the Observe and Session modes. It features a hands-free mode toggle, which allows parents to interact with the app without needing to physically engage with the device. The interface indicates when the app is actively listening for speech input, facilitating real-time assistance during conversations with the child. FIG. 3 illustrates the interface of the AI4Echolalia™ app when it responds to parents during an active session. This screen demonstrates the app's capability to interact with parents by providing real-time feedback, recommendations, and prompts to enhance their child's speech development and reduce instances of echolalia. The message “AI4Echolalia is responding . . . ” indicates that the app is actively processing the conversation and generating helpful suggestions tailored to the specific interaction. This interactive design aims to empower parents with practical strategies for engaging their child effectively, facilitating better communication, and promoting spontaneous speech responses. FIG. 4 illustrates the interface of the AI4Echolalia™ app when the user toggles the chat option to view the app's responses in text format. This feature allows parents to read the app's feedback and recommendations during their interaction with their child, providing a reference for moments when the spoken feedback may be missed. The display shows a conversational flow, where the app acknowledges the parent's efforts and offers strategies for encouraging spontaneous responses from the child.

### DETAILED DESCRIPTION OF THE INVENTION

The present invention, AI4Echolalia™, is an AI-powered educational tool designed to assist parents in managing their child's speech development, particularly for children with special needs such as echolalia. The app serves as a complementary tool to professional speech therapy, offering real-time assistance that fills the gap between formal therapy sessions and the ongoing, daily needs of speech development. The invention utilizes generative AI technologies, including speech-to-text, text-to-speech, and large language models (LLMs), to provide personalized support. The system detects and differentiates between immediate and delayed echolalia, offering tailored guidance to parents during conversations with their child. By analyzing the child's speech patterns, the app provides parents with prompts, feedback, and suggestions in real-time to encourage spontaneous communication and minimize repetitive echolalia responses. Unique Dataset for Personalized Feedback: A critical component of the AI4Echolalia™ system is the creation of a unique dataset derived from the inventor's personal experience with their own child's speech development. This dataset includes: Prompts designed to reduce echolalia, Child responses to those prompts, and Follow-up prompts aimed at addressing both immediate and delayed echolalia. This dataset serves as a vital input for training the app's Language Learning Model (LLM), which enables more accurate analysis and response generation during parent-child conversations. The dataset allows the LLM to reason more effectively, offering context-aware suggestions tailored to the specific needs of the child. This unique approach ensures that the feedback provided by the app is not only highly personalized but also more effective in reducing echolalia, as observed in experimental use cases with the inventor's child. Through extensive testing, it was observed that the app's ability to generate personalized feedback improves significantly over time as the LLM learns from each interaction, continuously refining its understanding of the child's speech patterns and responding with greater accuracy. Key Components: Real-time Speech Processing: The app leverages a Transcription API (such as Whisper) to convert speech to text, enabling the analysis of parent-child interactions. The transcribed speech is then processed by the LLM API (e.g., GPT-4 or equivalent) to detect speech characteristics and patterns specific to echolalia. By identifying whether a child is engaging in immediate or delayed echolalia, the system can provide targeted feedback to the parent, improving the effectiveness of their engagement with the child. Session and Observation Modes: The app provides two modes for interaction: Session Mode and Observation Mode. In Session Mode, parents engage directly with the child while the app listens and responds in real-time, providing prompts and strategies to improve speech. In Observation Mode, the app simply monitors the conversation, offering suggestions only when the parent requests guidance. This allows parents to balance active intervention with passive observation depending on the situation. Interactive and Hands-Free Mode: AI4Echolalia™ offers a hands-free mode to allow parents to interact with the app while focusing entirely on their child, without needing to interact physically with the device. This feature enhances usability, making the app accessible in a variety of contexts, including during playtime or other dynamic environments. Transcription and Feedback History: Each session is logged, and transcripts of conversations are saved within the app. This allows parents to review past sessions and observe improvements over time. The app's AI continuously refines its recommendations by analyzing the stored sessions, providing more personalized and adaptive feedback in future sessions based on historical data. Prompt Engineering and Personalized Feedback: The app employs prompt engineering to deliver prompts tailored to each child's specific speech development needs. For example, if a child struggles with object identification, the app may suggest using a fill-in-the-blank technique (“This is an ___”) to encourage more spontaneous responses. The system adapts over time, providing feedback that evolves with the child's progress. Real-Time Feedback and AI Guidance: As demonstrated in FIG. 3, the app responds in real-time to parent-child conversations, providing immediate feedback when echolalia is detected. This includes guidance on how to steer conversations in a way that reduces repetitive speech patterns and encourages more original speech from the child. Multimodal Interaction: For instances where parents miss spoken instructions, the app also provides a text-based chat option, as shown in FIG. 4. This feature allows parents to refer back to the app's recommendations at any time and offers a secondary mode of interaction for reviewing feedback after the session. Scalability and Cloud Integration: The app is designed with scalability in mind, leveraging cloud technologies to ensure it can support large numbers of users and continuously improve through data-driven refinement. The backend server, built using technologies like Flask, facilitates seamless communication between the client (the app) and the AI components, ensuring responsive interaction for users. Ethical Considerations and Responsible AI: A key feature of the app is the inclusion of a Responsible AI Agent to ensure that all interactions remain ethical and privacy-conscious. This module governs data collection, ensuring that all data used for analysis is anonymized and complies with data protection regulations.

1. A method for assisting parents in the speech development of children with echolalia, comprising: Capturing and transcribing real-time speech interactions between a parent and child using a speech-to-text API; Processing the transcribed speech using a Language Learning Model (LLM) to detect speech patterns indicative of immediate and delayed echolalia; Generating personalized feedback and prompts for the parent based on the detected speech patterns to encourage spontaneous speech in the child; Storing the transcriptions and feedback in a session log for future reference and analysis; Adapting future feedback based on the historical data collected in previous sessions, providing personalized and adaptive prompts to reduce echolalia over time.

2. The method of claim 1, further comprising: Providing parents with the option to toggle between a session mode and observation mode, wherein session mode offers real-time feedback, and observation mode allows passive monitoring of the interaction without immediate intervention.

3. The method of claim 1, further comprising: Offering a hands-free mode that allows parents to receive real-time feedback without physically interacting with the app during the session.

4. The method of claim 1, wherein the feedback and prompts are generated using a unique dataset created from interactions with children exhibiting echolalia, said dataset including: Initial prompts, Child responses to said prompts, Follow-up prompts, and wherein the dataset is used to train the LLM to provide more personalized and contextually accurate feedback to the parent.

5. The method of claim 1, further comprising: Providing feedback in both audio and text formats, wherein parents can refer to the text format for reviewing feedback during or after the session.

6. A system for assisting parents in managing a child's speech development, comprising: A client-side application for capturing speech interactions between a parent and child; A server-side system utilizing a transcription API to convert speech to text; A Language Learning Model (LLM) for analyzing the transcribed speech to detect immediate or delayed echolalia; A feedback module for generating personalized prompts based on the echolalia detected; A data storage module for logging session transcripts and feedback for future reference; A user interface enabling parents to toggle between session mode, observation mode, and hands-free mode.

7. The system of claim 6, wherein the system employs a Responsible AI Agent to ensure that all data is processed in compliance with privacy regulations and ethical standards.

8. The system of claim 6, wherein the feedback module provides suggestions based on a historically-generated dataset that adapts over time, refining the LLM's ability to reduce both immediate and delayed echolalia through real-time interventions.

9. A method for reducing echolalia in children with speech delays, comprising: Analyzing the speech of children during parent-child interactions using AI-driven models; Using a dataset of known echolalia speech patterns to generate prompts that guide parents in responding effectively; Providing immediate feedback to reduce repetitive speech patterns and encouraging spontaneous speech responses through tailored interventions.

10. The method of claim 9, further comprising: Storing and analyzing previous session data to improve the accuracy and personalization of future interactions using the system.
